(19) United States
(12) Patent Application Publication
(10) Pub. No.: US 2022/0215364 A1
(43) Pub. Date: Jul. 7, 2022

(54) ELECTRONIC DEVICE, MANAGEMENT METHOD OF ELECTRONIC DEVICE, AND PROGRAM

(71) Applicant: Sharp NEC Display Solutions, Ltd., Tokyo (JP)

(72) Inventors: Katsuyuki TAKEUCHI, Tokyo (JP); Masakazu KOBAYASHI, Tokyo (JP)

(21) Appl. No.: 17/702,469

(22) Filed: Mar. 23, 2022

Related U.S. Application Data
(63) Continuation of application No. PCT/JP2019/038187, filed on Sep. 27, 2019.

(51) Int. Cl. G06Q 20/14; G06Q 20/12; H04L 9/32

(52) U.S. Cl. CPC G06Q 20/145; H04L 9/3247; G06Q 20/127

(57) ABSTRACT

An operation condition storage stores information of operation conditions about an electronic device. A time information storage stores time information associated with the information of operation conditions. When the electronic device can be connected to the Internet, information stored in the operation condition storage and information stored in the time information storage may be regularly stored in an external server of the electronic device. A change input receives a change input for temporarily changing the information of operation conditions and receives change period information for specifying an applicable period of the changed information of operation conditions. These inputs are performed, for example, by operating, by a user, an input device (for example, a button or a touch panel) provided in the electronic device. A changer changes the time information using the changed information of operation conditions and the applicable period.

### TECHNICAL FIELD

The present invention relates to an electronic device, a method for managing an electronic device, and a program.

### BACKGROUND ART

In recent years, electronic devices such as projectors and displays have been utilized in various places. Generally, these electronic devices are sold to users and then utilized in many cases.

Patent Literature 1 describes a system for a user to utilize a service that is charged for. In this system, processing relating to charging of the user is performed through a centralized management platform.

### CITATION LIST

### Patent Literature

### Patent Literature 1

Published Japanese Translation No. 2004-545014 of the PCT International Publication

### SUMMARY OF INVENTION

### Technical Problem

The inventors of the present invention have considered lending an electronic device to a user and a consideration payment being made in exchange at the time of lending according to the operation conditions and a usage time of the electronic device. In this case, the user may want to temporarily change the operation conditions of electronic device in some cases. On the other hand, connecting the electronic device to the Internet may not be possible depending on a usage environment at the time of using the electronic device in some cases.

An object of the present invention is to be able to temporarily change the operation conditions of an electronic device even when the electronic device cannot be connected to the Internet when the electronic device is lent and a consideration payment is made in exchange at the time of lending according to the operation conditions and a usage time of the electronic device.

### Solution to Problem

According to the present invention,

an electronic device includes:

an operation condition storage storing information of operation conditions which specifies the operation conditions of the electronic device;

a time information storage storing time information that is information for specifying a usable time or an expiration period of the electronic device in the information of operation conditions;

a change input receiving a change input for temporarily changing the information of operation conditions and receive change period information which specifies an applicable period of the changed information of operation conditions; and

a changer changing the time information using the changed information of operation conditions and the applicable period.

According to the present invention,

a management method of an electronic device includes:

storing information of operation conditions which specifies the operation conditions of the electronic device;

storing time information that is information for specifying a usable time or an expiration period of the electronic device in the information of operation conditions;

receiving a change input for temporarily changing the information of operation conditions and receive change period information which specifies an applicable period of changed information of operation conditions; and

changing the time information using the changed information of operation conditions and the applicable period.

According to the present invention,

a program causes an electronic device to perform:

a function of storing information of operation conditions which specifies the operation conditions of the electronic device;

a function of storing time information that is information for specifying a usable time or an expiration period of the electronic device in the information of operation conditions;

a function of receiving a change input for temporarily changing the information of operation conditions and receive change period information which specifies an applicable period of changed information of operation conditions; and

a function of changing the time information using the changed information of operation conditions and the applicable period.

### Advantageous Effects of Invention

According to the present invention, it is possible to temporarily change the operation conditions of an electronic device even when the electronic device cannot be connected to the Internet when the electronic device is lent and a consideration payment is made in exchange at the time of lending according tor the operation conditions and a usage time of the electronic device.

### BRIEF DESCRIPTION OF DRAWINGS

The above-described object, other objects, features, and advantages will be further clarified through preferred embodiments which will be described later and the following accompanying drawings.

FIG. 1 is a diagram showing an example of a constitution of a function of an electronic device according to an embodiment.

FIG. 2 is a diagram showing an example of information stored in an operation condition storage.

FIG. 3 is a diagram showing an example of information stored in a time information storage.

FIG. 4 is a block diagram illustrating a constitution of hardware of a main part of the electronic device.

FIG. 5 is a diagram showing a first example of processing performed by the electronic device.

FIG. 6 is a diagram showing a second example of the processing performed by the electronic device.

FIG. 7 is a diagram showing a detailed example of Step S120 of FIG. 6.

FIG. 8 is a diagram showing an example of subsequent processing with respect to FIG. 7.

FIG. 9 is a diagram showing a detailed example of Step S140 of FIG. 6.

### DESCRIPTION OF EMBODIMENTS

Embodiments of the present invention will be described below with reference to the drawings. Constituent elements that are the same in all of the drawings will be denoted by the same reference numerals and description thereof will be omitted as appropriate.

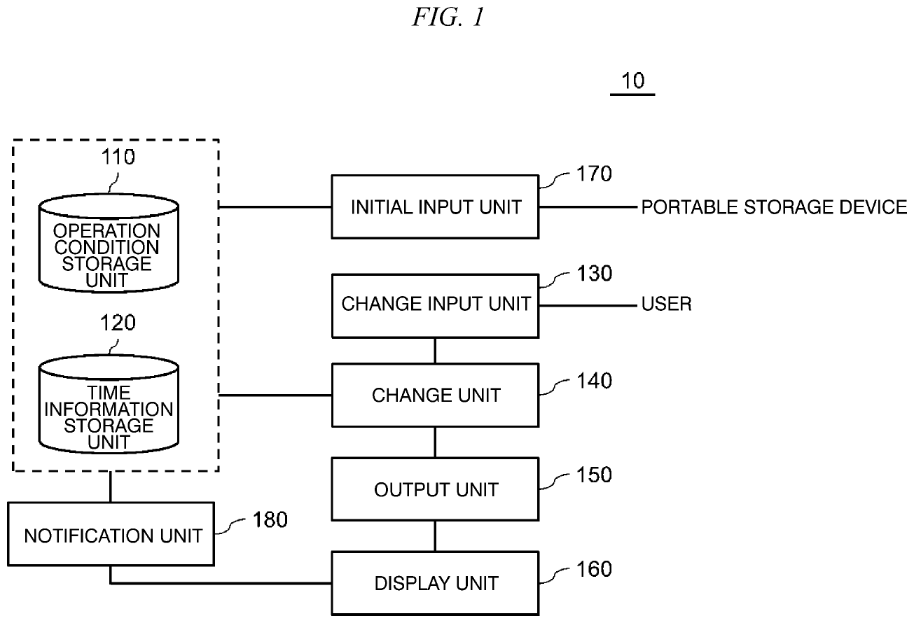

FIG. 1 is a diagram showing an example of a constitution of a function of an electronic device 10 according to an embodiment. The electronic device 10 shown in this drawing is, for example, an office apparatus and lent to a user. The electronic device 10 is, for example, a display apparatus such as a display or a projector, but may a copying machine or a multifunctional machine having a copying function and a fax function.

In this embodiment, the electronic device 10 is not connected to the Internet. For this reason, it is difficult to charge for the electronic device 10 on a pay-as-you-go basis. Thus, the user makes a consideration payment in advance in exchange for the lending (hereinafter referred to as a “prepaid money amount”). A usable time of the electronic device 10 is determined in accordance with the prepaid money amount. Furthermore, the electronic device 10 stores information (hereinafter referred to as “time information”) for specifying a current usable time (the remaining time of a usable time) and renews the information in accordance with a total time for which the electronic device 10 has already been used. In addition, a controller of the electronic device 10 makes a function as the electronic device 10 stop working when the usable time becomes zero.

A consideration payment for the electronic device 10 per unit time can be changed depending on an operation state of the electronic device 10 when the electronic device 10 is used. Operation states available for the electronic device 10 may vary depending on a type of contract selected by the user (for example, a contract plan). As an example, when the lifespan of the parts constituting the electronic device 10 differs depending on an operation state (for example, a ratio of an available output to a rated output), a unit price per unit time varies depending on an operation state permitted by the contract. For this reason, even if prepaid money amounts are the same, the usable time of the electronic device 10 may vary depending on the selected contract plan. In this embodiment, the electronic device 10 stores information for specifying the selected type of contract (hereinafter referred to as “information of operation conditions”).

For example, when the electronic device 10 is a projector, a light source is prone to deterioration. Furthermore, an output of the light source available for the electronic device 10 (that is, the brightness of a projector) varies depending on the contract plan. For this reason, the usable time or the prepaid money amount of the electronic device 10 varies depending on the contract plan. This output is determined, for example, on the basis of the rated output of the light source.

On the other hand, some users of the electronic device 10 may want to temporarily change the operation conditions of the electronic device 10 during a contract period in some cases. In this case, a user makes an input to the electronic device 10 to temporarily change the operation conditions. Furthermore, the electronic device 10 measures a length of a time for which the electronic device 10 is actually used under the changed operation conditions (hereinafter referred to as an “actual usage time”) and corrects the usable time in accordance with the length of the actual usage time.

To be specific, the electronic device 10 includes an operation condition storage 110, a time information storage 120, a change input 130, and a changer 140. The operation condition storage 110 stores information of operation conditions of the electronic device 10. The time information storage 120 stores time information in the information of operation conditions. When the electronic device 10 can be connected to the Internet, the information stored in the operation condition storage 110 and the information stored in the time information storage 120 may be regularly stored in an external server of the electronic device 10. The change input 130 receives a change input for temporarily changing the information of operation conditions and receives change period information for specifying an applicable period of the changed information of operation conditions. These inputs are performed, for example, by operating, by a user, an input device (for example, a button or a touch panel) provided in the electronic device 10. The changer 140 changes the time information using the changed information of operation conditions and the applicable period.

Also, when the electronic device 10 is used even when the operation conditions are not changed, the changer 140 renews the time information in accordance with the usage time thereof. For example, when the time information includes the usable time, the changer 140 subtracts the used time from the usable time. Furthermore, when the usable time includes the remaining amount of the prepaid money amount, the changer 140 subtracts a value obtained by multiplying the used time by a current unit price of the contract plan from the remaining amount.

In the example shown in this drawing, the electronic device 10 further includes an output 150 and a display 160. The output 150 outputs at least one of the usable time and an expiration period calculated using the usable time. An example of an output destination using the output 150 is the display 160. The display 160 is, for example, a liquid crystal display or a touch panel (in this case, also serves as an input device) and displays information output by the output 150. Thus, for example, a user of the electronic device 10 can use the electronic device 10 and then confirm at least one of the usable time and the expiration period after the use.

When the electronic device 10 is a display, the display 160 may be a display panel as a display. Furthermore, when the electronic device 10 is a projector, the display 160 may be a projection unit of the projector. In these cases, it is preferable that the output 150 output the above-described information at a timing at which a user starts using the electronic device 10 (that is, when a power button is turned on) and when the user ends the use of the electronic device 10 (that is, when the power button is turned off).

In the example shown in this drawing, the electronic device 10 further includes an initial input 170 and a notifier 180. The initial input 170 acquires first information of operation conditions, that is, information of operation conditions at the time of performing lending, stores the information of operation conditions in the operation condition storage 110, acquires first time information, that is, time information at the time of performing lending, and stores the time information in the time information storage 120. The electronic device 10 may not be connected to the Internet in some cases. In this case, the initial input 170 acquires the information of operation conditions at the time of performing lending and the time information at the time of performing lending from a portable storage apparatus (for example, a portable memory). Here, when the electronic device 10 can be connected to the Internet, the initial input 170 may acquire the information of operation conditions at the time of performing lending and the time information at the time of making a contract over the Internet.

The notifier 180 outputs a prescribed notification when the time reaches a timing at which the contract for using the electronic device 10 ends. This notification is, for example, to display a prescribed character string on the display 160. The notifier 180 determines whether the time has reached the timing at which the contract for using the electronic device 10 ends on the basis of a determination concerning whether a difference between the expiration period and a current date and time of the electronic device determined through the time information satisfies a reference (as an example, whether the difference is less than or equal to a prescribed value).

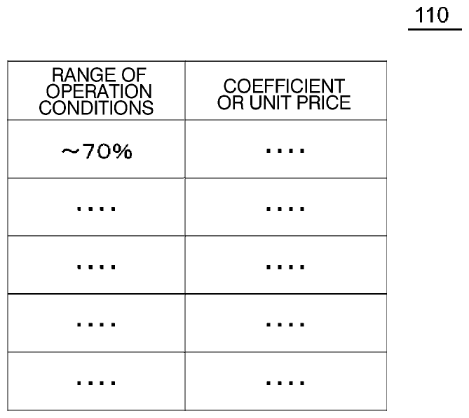

FIG. 2 is a diagram showing an example of information stored in the operation condition storage 110. In the example shown in this drawing, the operation condition storage 110 stores a “coefficient” or a “unit price” as the information of operation conditions for each range of the operation conditions of the electronic device 10. When the range of the operation conditions is determined through the contract plan, the operation condition storage 110 may further store a contract plan name.

For example, when the electronic device 10 is a projector, the operation conditions of the electronic device 10 includes a model number of the electronic device 10, a model number of a light source included in the electronic device 10, and an output available for the light source (for example, a relative value based on a rated output).

The “coefficient” is a ratio of a unit price within the range of the operation conditions that are references or an operable time when the same prepaid money amount is paid to the unit price within the range. Furthermore, the time information indicates the usable time. In addition, the changer 140 determines a coefficient on the basis of a combination of the unchanged information of operation conditions and the changed information of operation conditions and calculates the changed usable time using this coefficient.

For example, when the “coefficient” stored in the operation condition storage 110 is the ratio of the unit price, the changer 140 determines the “unchanged ‘coefficient’/the changed ‘coefficient’” as a coefficient used herein. Furthermore, when the “coefficient” stored in the operation condition storage 110 is the ratio of the operable time, the changer 140 determines the “changed ‘coefficient’/the unchanged ‘coefficient’” as a coefficient used herein. Furthermore, the changer 140 calculates an amount of decrease in the usable time by multiplying the actual usage time of the electronic device 10 under the changed operation conditions by this coefficient. In addition, the changed usable time is calculated by subtracting this amount of decrease from the usable time stored in the time information storage 120.

Also, “unit price” (an example of a constant) is a unit price per unit actual usage time in the contract plan. In this case, the time information is the remaining amount of the prepaid money amount (that is, a value obtained by subtracting the “actual usage time of the electronic device 10 so far”×the “unit price per hour” from the prepaid money amount). Furthermore, the changer 140 calculates an amount of decrease in the remaining amount from this remaining amount by multiplying the actual usage time of the electronic device 10 under the changed operation conditions by the “unit price” under the changed operation conditions. In addition, the changer 140 calculates the changed remaining amount by subtracting the calculated amount of decrease from the remaining amount stored in the time information storage 120.

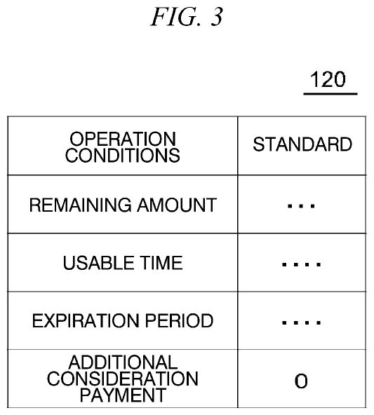

FIG. 3 is a diagram showing an example of information stored in the time information storage 120. In the example shown in this drawing, the time information storage 120 stores the currently selected range of the operation conditions, the remaining amount, the usable time, and the expiration period. Here, it may not be possible to set the expiration period depending on the type of electronic device 10 and the contract plan in some cases. In this case, the time information storage 120 does not store the expiration period.

Also, the time information storage 120 stores an additional consideration payment to be paid to an owner of the electronic device 10 by a user of the electronic device 10 at the time of the next contract renewal. This additional consideration payment may occur when the user of the electronic device 10 temporarily changes the operation conditions of the electronic device 10, for example, as will be described later.

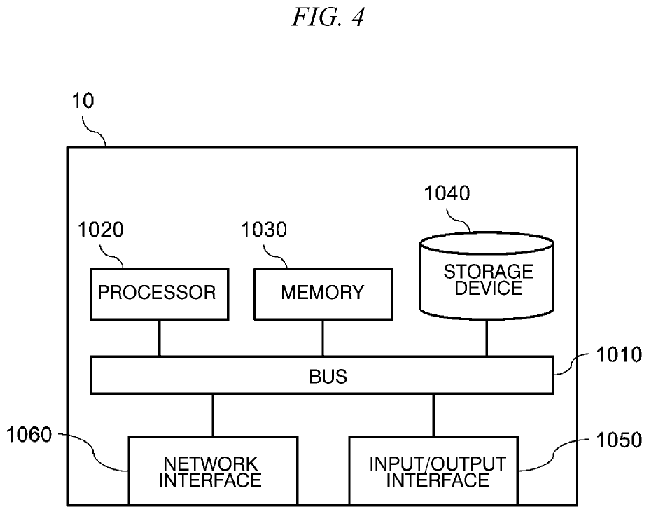

FIG. 4 is a block diagram illustrating a constitution of hardware of a main part of the electronic device 10. This main part has a bus 1010, processors 1020, a memory 1030, a storage device 1040, an input/output interface 1050, and a network interface 1060.

The bus 1010 is a data transmission path through which the processors 1020, the memory 1030, the storage device 1040, the input/output interface 1050, and the network interface 1060 transmit and receive data to and from each other. Here, a method for connecting the processors 1020 or the like to each other is not limited to connection through the bus.

The processors 1020 is a processor realized through a central processing unit (CPU), a graphics processing unit (GPU), or the like.

The memory 1030 is a main storage apparatus realized through a random access memory (RAM) or the like.

The storage device 1040 is an auxiliary storage apparatus realized through a hard disk drive (HDD), a solid state drive (SSD), a memory card, a read only memory (ROM), or the like. The storage device 1040 stores program modules which realize functions of (for example, the change input 130, the changer 140, the output 150, the initial input 170, and the notifier 180) of the electronic device 10. When the processors 1020 reads each of these program modules on the memory 1030 and executes the program module, each of the functions corresponding to each of the program modules is realized. Furthermore, the storage device 1040 also functions as various storages (for example, the operation condition storage 110 and the time information storage 120).

The input/output interface 1050 is an interface through which the main part of the electronic device 10 is connected to various input/output machines (for example, the display 160).

The network interface 1060 is an interface through which the electronic device 10 is connected to other apparatuses on the network. Here, the network interface 1060 may not be utilized in some cases.

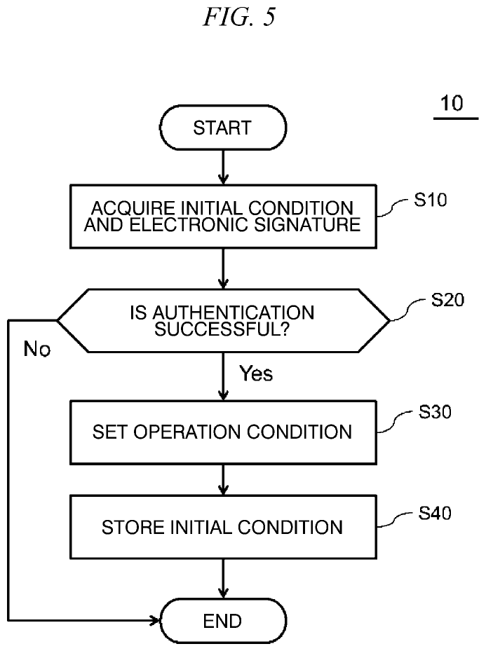

FIG. 5 is a diagram showing a first example of processing performed by the electronic device 10. The process shown in this drawing is a process in which the electronic device 10 acquires first information of operation conditions and first time information (hereinafter referred to as “initial conditions”).

The initial conditions are stored in a portable memory. A user of the electronic device 10 or an owner of the electronic device 10 (in the case of a corporation, he/she may be a sales representative of the corporation in some cases) inserts a portable memory having the initial conditions stored therein into the terminal of the electronic device 10. In this memory, an electronic signature is associated with the initial conditions. Furthermore, when the initial conditions and the electronic signature are read (Step S10) and the electronic device 10 succeeds in authenticating the electronic signature (Step S20: Yes), the initial input 170 of the electronic device 10 sets the first operation conditions included in the initial conditions in the electronic device 10 (Step S30). Moreover, the initial input 170 stores first information of operation conditions in the operation condition storage 110 and stores first time information in the time information storage 120 (Step S40).

As described above, the process shown in Step S10 may be performed over the Internet.

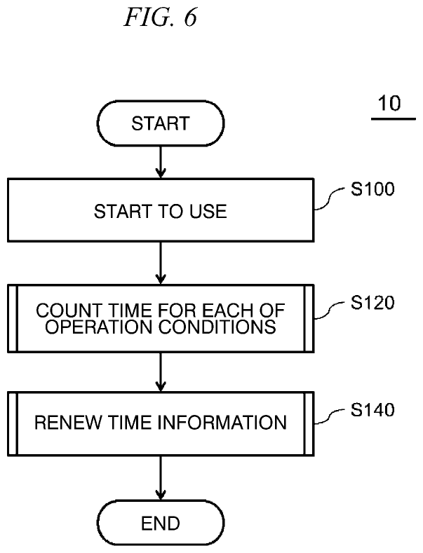

FIG. 6 is a diagram showing a second example of processing performed by the electronic device 10. The process shown in the drawing is a process performed while the electronic device 10 is in use.

First, a user of the electronic device 10 turns on the power of the electronic device 10 and performs a prescribed operation as necessary. Thus, the use of the electronic device 10 is started (Step S100). After that, the changer 140 of the electronic device 10 counts the actual usage time of the electronic device 10 for each of the operation conditions until the use of the electronic device 10 is completed (Step S120). In addition, after the use of the electronic device 10 is completed, the changer 140 renews the time information (Step S140).

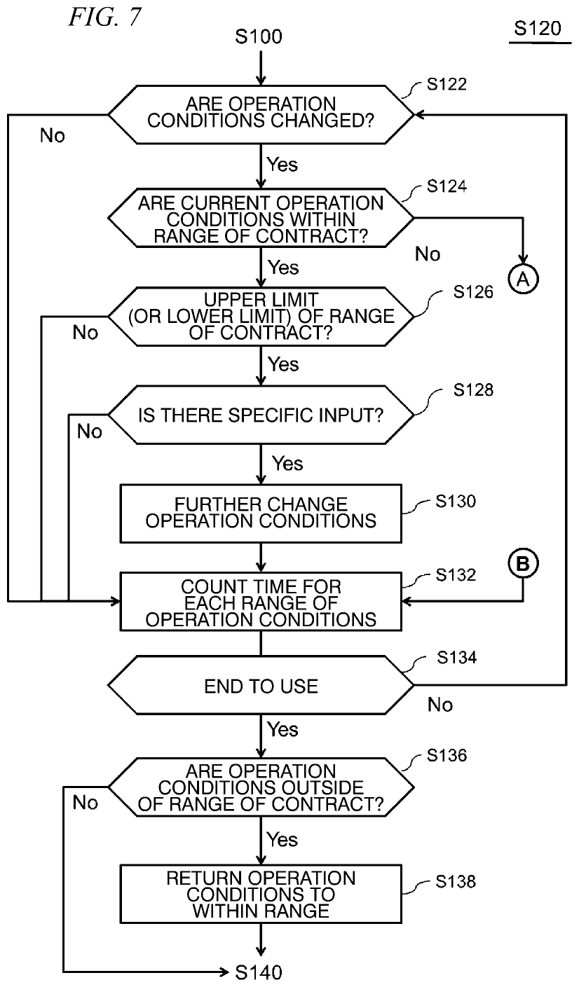

FIG. 7 is a flowchart showing an example of the process performed in Step S120 of FIG. 6. When a user does not make an input to change the operation conditions of the electronic device 10 (Step S122: No), the changer 140 of the electronic device 10 adds a time during which the electronic device 10 has been used this time to the actual usage time under the current operation conditions (Step 132).

A user may want to change the operation conditions of the electronic device 10 while the electronic device 10 is being used. In this case, the user makes an input to change the operation conditions of an operation unit of the electronic device 10 (Step S122: Yes). For example, when the electronic device 10 is a display, the user makes an input to change the brightness of the display, for example, via an operation button. Furthermore, when the electronic device 10 is a projector, the user makes an input to change the brightness of the light source, for example, via an operation button.

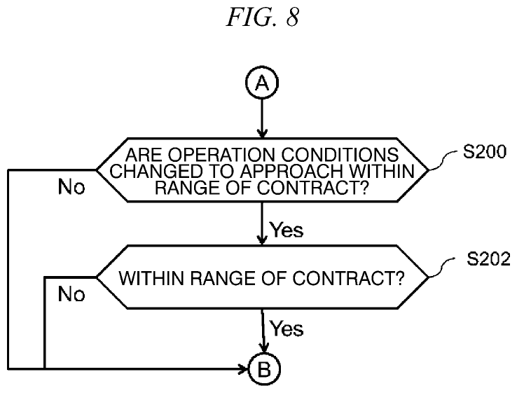

Here, the changer 140 confirms whether the current operation conditions are within the range of the contract. When it is confirmed that the current operation conditions are outside of the range of the contract (Step S124: No), the changer 140 performs the process shown in FIG. 8.

When it is confirmed that the current operation conditions are within the range of the contract (Step S124: Yes), the changer 140 confirms whether the operation conditions have reached an upper limit or a lower limit of the current range of the contract (Step S126). When it is confirmed that the operation conditions have not reached the upper limit or the lower limit, that is, the operation conditions are within the current range of the contract (Step S126: No), then the changer 140 adds a time during which the electronic device 10 has been used to the actual usage time under the current operation conditions (Step S132).

On the other hand, when it is confirmed that the operation conditions have reached the upper limit (or lower limit) of the current range of the contract (Step S126: Yes), the changer 140 maintains the operation conditions at the upper limit (or lower limit) until there is a specifically identified input (for example, an input of a button different from the operation button to change the operation conditions) (Step S128: No) even if the change input of the operation conditions is continued and adds a time during which the electronic device 10 has been used this time to the actual usage time under the current operation conditions (Step S132). On the other hand, in the case in which it is confirmed that there is the specifically identified input (Step S128: Yes), the changer 140, when it is confirmed that the change input of the operation conditions is continued (or at the same time as a specifically identified dormitory), the changer 140 changes the operation conditions outside of the current range of the contract in accordance with the change input (Step S130). As an example, the changer 140 makes the brightness of the display larger than the upper limit of the contract. Furthermore, as another example, the changer 140 makes the brightness of the light source of the projector larger than the upper limit of the contract. In addition, after the operation conditions have been changed, the changer 140 adds a time during which the electronic device 10 has been used to the actual usage time under the changed operation conditions (Step S132). In other words, the timing at which the input for making the operation conditions be outside of the range of the contract has been performed also indicates a timing at which the applicable period under the changed operation conditions is started.

The changer 140 repeatedly performs the processes shown in Step S122 to Step S132 until an input for completing the use of the electronic device 10 (for example, turning off the power button) is made (Step S134: No). On the other hand, when the input for completing the use of the electronic device 10 is made (Step S134: Yes), the changer 140 confirms the current operation conditions. When it is confirmed that the current operation conditions are outside of the range of the contract (Step S136: Yes), the operation conditions of the electronic device 10 return within the range of the contract, for example, the upper limit or the lower limit of the range (Step S138). In other words, the input for completing the use of the electronic device 10 also serves as the input for returning the operation conditions to within the range of the contract. Moreover, this input also indicates the timing at which the applicable period ends under the changed operation conditions. After that, the electronic device 10 performs the process shown in Step S140.

When the electronic device 10 is a projector, the input for completing the use of the electronic device 10 may be an input for turning off the light source. Furthermore, the process shown in Step S138 may be performed immediately after the next turned-on of the power supply.

FIG. 8 is a flowchart showing an example of the process after the process of Step S124 of FIG. 7. When it is confirmed that the current operation conditions are outside of the range of the contract (Step S124: No in FIG. 7) and a user's input indicates that the operation conditions are changed to be away from the range of the contract (Step S200:

No), the changer 140 adds a time during which the electronic device 10 has been used this time to the actual usage time under the current operation conditions (Step 132 in FIG. 7). On the other hand, when it is confirmed that the current operation conditions are outside of the range of the contract (Step S124: No in FIG. 7), the user's input indicates that the operation conditions are changed to be away from the range of the contract (Step S200: Yes), and the operation conditions return within the range of the contract (Step S202: Yes), then the changer 140 adds a time during which the electronic device 10 has been used to an operation actual time corresponding to the range of the contract (Step S132 in FIG. 7). When it is confirmed that the operation conditions do not return within the range of the contract (Step S202: No), then the changer 140 adds a time during which the electronic device 10 has been used to the operation actual time corresponding to the current range (Step S132 in FIG. 7).

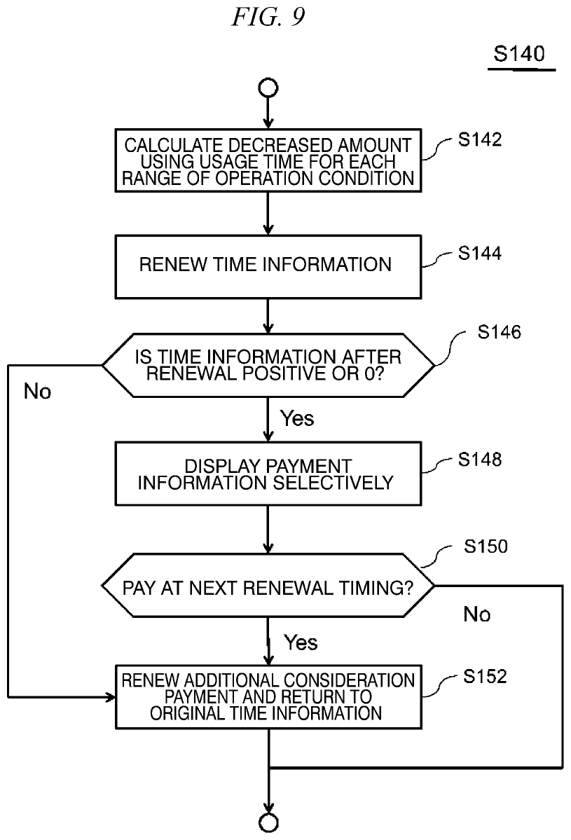

FIG. 9 is a flowchart showing an example of the process performed in Step S140 of FIG. 6. First, the changer 140 calculates an amount of decrease of the time information using the actual usage time of the operation conditions for each of the ranges of the operation conditions. An example of a method for calculating an amount of decrease of the time information is as described with reference to FIG. 2 (Step S142). Subsequently, the changer 140 renews the time information by subtracting the sum of these amounts of decrease from the time information stored in the time information storage 120 (Step S144). Here, the changer 140 makes it possible to return the time information to the state before the renewal.

Here, the renewed time information may be negative in some cases. When it is confirmed that the renewed time information is negative (Step S146: No), a consideration payment corresponding to this negative amount is added to an additional consideration payment amount stored in the time information storage 120 and the time information renewed in Step S144 is returned to the original time information (Step S152). For example, when the time information is the remaining amount of the prepaid money amount, the negative amount is an additional consideration payment as it is. On the other hand, when the time information is the usable time, the changer 140 calculates an additional consideration payment amount, for example, by multiplying the unit price under the operation conditions in a state in which the contract has been made by this negative amount.

On the other hand, when the renewed time information is positive or 0 (Step S146: Yes), the changer 140 causes a screen for allowing a user to select a consideration payment method for the use of the electronic device 10 this time to be displayed on the display 160 of the electronic device 10. A selection option is a determination concerning whether to return the time information to the original time information by performing payment at the time of performing the next contract renewal. When it is confirmed that the user selects to perform payment at the time of performing the next contract renewal (Step S150: Yes), the changer 140 adds the consideration payment according to the amount of decrease calculated in Step S142 to the additional consideration payment amount stored in the time information storage 120 and returns the time information renewed in Step S144 to the original time information (Step S152). On the other hand, when it is confirmed that the user does not select to perform payment at the time of performing the next contract renewal (Step S150: No), the changer 140 decides the renewed time information.

As described above, according to this embodiment, the electronic device 10 stores the information (time information) which specifies the usable time of the electronic device 10 when the electronic device 10 is lent to the user. Moreover, if the operation conditions of the electronic device 10, that is, the contract plan is temporarily changed, when calculation according to the changed operation conditions and the actual usage time under the changed operation conditions is performed, the time information is renewed. Therefore, even if the electronic device 10 is not connected to the Internet, a user of the electronic device 10 can temporarily use the operation conditions outside of the range determined in the contract.

Although the embodiments of the present invention have been described above with reference to the drawings, these embodiments are examples of the present invention and various constitutions other than the above constitutions can be adopted.

Also, although a plurality of steps (processes) are described in order in the plurality of flowcharts used in the above description, the execution order of the steps performed in each of the embodiments is not limited to the order in the description. In each of the embodiments, the order of the illustrated steps can be changed within a range in which the contents are not hindered. Furthermore, the above-described embodiments can be combined as long as the contents do not conflict with each other.

Although some or all of the above embodiments may also be additionally described as follows, the present invention is not limited to the following description.

1. An electronic device, comprising:

an operation condition storage storing information of operation conditions which specifying the operation conditions of the electronic device;

a time information storage storing time information that is information for specifying at least one of a usable time and expiration period of the electronic device in the information of operation conditions;

a change input receiving a change input for temporarily changing the information of operation conditions and receive change period information which specifying an applicable period of the changed information of operation conditions; and

a changer changing the time information using the changed information of operation conditions and the applicable period.

2. The electronic device according to the above 1, wherein the time information indicates a usable time, and

the changer determines a coefficient on the basis of a combination of unchanged information of operation conditions and changed information of operation conditions and calculates changed time information using the coefficient.

3. The electronic device according to the above 1, wherein the time information indicates the remaining amount of a prepaid money amount, and

the changer calculates changed time information using a constant determined on the basis of the remaining amount and the changed information of operation conditions.

4. The electronic device according to any one of the above 1 to 3, the changer calculates the time information after the applicable period has expired,

further receives a selection input concerning whether to set the change of the time information or to perform another procedure without changing the time information, and

decides the renewal of the time information when receiving an input for setting the change of the time information.

5. The electronic device according to any one of the above 1 to 4, wherein the information of operation conditions indicates a range of the operation conditions, and

the change input is an input for making the operation conditions be outside of the range and a timing at which the input has been made indicates a timing at which the applicable period is started.

6. The electronic device according to the above 5, wherein a timing at which the applicable period ends is a timing at which an input for returning the operation conditions to within the range is performed.

7. The electronic device according to any one of the above 1 to 6, which includes an initial input acquiring the first information of operation conditions, storing the acquired first information of operation conditions in the operation condition storage, acquiring the first time information, and storing the acquired first time information in the time information storage.

8. The electronic device according to the above 7, wherein the first information of operation conditions and the first time information have electronic signatures attached thereto, and

the initial input stores the first operation conditions in the operation condition storage and stores the first time information in the time information storage when the electronic signature is authenticated.

9. The electronic device according to any one of the above 1 to 8, wherein the electronic device is a display apparatus or a projector.

10. A management method of an electronic device, which includes:

storing information of operation conditions which specifies the operation conditions of the electronic device;

storing time information that is information for specifying at least one of a usable time and expiration period of the electronic device in the information of operation conditions;

receiving a change input for temporarily changing the information of operation conditions and receive change period information which specifies an applicable period of changed information of operation conditions; and

changing the time information using the changed information of operation conditions and the applicable period.

11. The management method of an electronic device according to the above 10, wherein the time information indicates a usable time, and

the electronic device determines a coefficient on the basis of a combination of unchanged information of operation conditions and changed information of operation conditions and calculates changed time information using the coefficient.

12. The management method of an electronic device according to the above 10, wherein the time information indicates the remaining amount of a prepaid money amount, and

the electronic device calculates changed time information using a constant determined on the basis of the remaining amount and the changed information of operation conditions.

13. The management method of an electronic device according to any one of the above 10 to 12, wherein the electronic device calculates the time information after the applicable period has expired,

further receives a selection input concerning whether to set the change of the time information or to perform another procedure without changing the time information, and

decides the renewal of the time information when receiving an input for setting the change of the time information.

14. The management method of an electronic device according to any one of the above 10 to 13, wherein the information of operation conditions indicates a range of the operation conditions, and

the change input is an input for making the operation conditions be outside of the range and a timing at which the input is made indicates a timing at which the applicable period is started.

15. The management method of an electronic device according to the above 14, wherein a timing at which the applicable period ends is a timing at which an input for returning the operation conditions to within the range is performed.

16. The management method of an electronic device according to any one of the above 10 to 15, wherein the electronic device acquires and stores the first information of operation conditions and acquires and stores the first time information.

17. The management method of an electronic device according to the above 16, wherein the first information of operation conditions and the first time information have electronic signatures attached thereto, and

the electronic device stores the first operation conditions and stores the first time information when the electronic signature is authenticated.

18. The management method of an electronic device according to any one of the above 10 to 17, wherein the electronic device is a display apparatus or a projector.

19. A program causing an electronic device to serve:

a function of storing information of operation conditions which specifies the operation conditions of the electronic device;

a function of storing time information that is information for specifying at least one of a usable time and expiration period of the electronic device in the information of operation conditions;

a function of receiving a change input for temporarily changing the information of operation conditions and receive change period information which specifies an applicable period of changed information of operation conditions; and

a function of changing the time information using the changed information of operation conditions and the applicable period.

20. The program according to the above 19, wherein the time information indicates a usable time; and

the electronic device is caused to determine a coefficient on the basis of a combination of unchanged information of operation conditions and changed information of operation conditions and to calculate changed time information using the coefficient.

21. The program according to the above 19, wherein the time information indicates the remaining amount of a prepaid money amount, and

the electronic device is caused to calculate changed time information on the basis of a constant determined on the basis of the remaining amount and changed information of operation conditions.

22. The program according to any one of the above 19 to 21, wherein the electronic device is caused to calculate the time information after the applicable period has expired,

to further receive a selection input concerning whether to set the change of the time information or to perform another procedure without changing the time information, and

to decide the renewal of the time information when an input for setting the change of the time information is received.

23. The program according to any one of the above 19 to 22, wherein the information of operation conditions indicates a range of the operation conditions, and

the change input is an input for making the operation conditions be outside of the range and a timing at which the input is performed indicates a timing at which the applicable period is started.

24. The program according to the above 23, wherein a timing at which the applicable period ends is a timing at which an input for returning the operation conditions to within the range is performed.

25. The program according to any one of the above 19 to 24, wherein the electronic device is caused to acquire and store the first information of operation conditions and to acquire and store the first time information.

26. The program according to the above 25, wherein the first information of operation conditions and the first time information have electronic signatures attached thereto, and

the electronic device is caused to store the first operation conditions and to store the first time information when the electronic signature is authenticated.

27. The program according to any one of the above 19 to 26, wherein the electronic device is a display apparatus or a projector.

### REFERENCE SIGNS LIST

10 Electronic device

110 Operation condition storage

120 Time information storage

130 Change input

140 Changer

150 Output

160 Display

170 Initial input

180 Notifier

What is claimed is:

1. An electronic device, comprising:
an operation condition storage storing information of operation conditions which specifies the operation conditions of the electronic device;
a time information storage storing time information that is information for specifying at least one of a usable time and expiration period of the electronic device in the information of operation conditions;
a change input receiving a change input for temporarily changing the information of operation conditions and receive change period information which specifies an applicable period of the changed information of operation conditions; and
a changer changing the time information using the changed information of operation conditions and the applicable period.

2. The electronic device according to claim 1, wherein the changer determines a coefficient on the basis of a combination of an unchanged information of operation conditions and the changed information of operation conditions and calculates changed time information using the coefficient.

3. The electronic device according to claim 1, wherein the time information indicates the remaining amount of a prepaid money amount, and
the changer calculates changed time information using a constant determined on the basis of the remaining amount and the changed information of operation conditions.

4. The electronic device according to claim 1, wherein the changer calculates the time information after the applicable period has expired,
the changer further receives a selection input concerning whether to set the change of the time information or to perform another procedure without changing the time information, and
the changer decides the renewal of the time information when receiving an input for setting the change of the time information.

5. The electronic device according to claim 1, wherein the information of operation conditions indicates a range of the operation conditions, and
the change input is an input for making the operation conditions be outside of the range and a timing at which the input has been made indicates a timing at which the applicable period is started.

6. The electronic device according to claim 5, wherein a timing at which the applicable period ends is a timing at which an input for returning the operation conditions to within the range is performed.

7. The electronic device according to claim 1, further comprising:
an initial input acquiring the first information of operation conditions, storing the acquired first information of operation conditions in the operation condition storage, acquiring the first time information, and storing the acquired first time information in the time information storage.

8. The electronic device according to claim 7, wherein the first information of operation conditions and the first time information have electronic signatures attached thereto, and
the initial input stores the first operation conditions in the operation condition storage and stores the first time information in the time information storage when the electronic signature is authenticated.

9. The electronic device according to claim 1, wherein the electronic device is one of a display apparatus and a projector.

10. A management method of an electronic device, comprising:
storing information of operation conditions which specifies the operation conditions of the electronic device;
storing time information that is information for specifying at least one of a usable time and expiration period of the electronic device in the information of operation conditions;
receiving a change input for temporarily changing the information of operation conditions and receive change period information which specifies an applicable period of a changed information of operation conditions; and
changing the time information using the changed information of operation conditions and the applicable period.

11. A non-transitory computer readable storage medium that stores a computer program that causes an electronic device to perform:
a function of storing information of operation conditions which specifies the operation conditions of the electronic device;
a function of storing time information that is information for specifying at least one of a usable time and expiration period of the electronic device in the information of operation conditions;
a function of receiving a change input for temporarily changing the information of operation conditions and receive change period information which specifies an applicable period of a changed information of operation conditions; and
a function of changing the time information using the changed information of operation conditions and the applicable period.
